(19) United States
(12) Patent Application Publication
(10) Pub. No.: US 2006/0056570 A1
(43) Pub. Date: Mar. 16, 2006

(54) Fission fragment propulsion for space applications

(76) Inventor: Donald Gene Sutherland, Folsom, CA (US)

Correspondence Address: Donald G. Sutherland, 185 North Grant Lane, Folsom, CA, 95630, US

(21) Appl. No.: 10/939,567

(22) Filed: Sep. 14, 2004

(51) Int. Cl. G21D 5/02

(52) U.S. Cl. 376/318

(57) ABSTRACT

A unique method to perform space propulsion is disclosed, which directly uses the kinetic energies of nuclear fission atom fragments to generate thrust. At the moment of fission, approximately 85% of the total energy is kinetic, contained within fission fragments traveling at 4% the speed of light. The propulsion of rockets and other space devices is conventionally accomplished by hurtling mass overboard at high velocities. An important parameter for quantifying propulsion performance is specific impulse (Isp). Propulsion technologies that support today's rocket missions are primarily based on chemical reactions to produce thrust, and are characterized by Isp values peaking at about 400 seconds. Advanced space concepts using nuclear energy to heat and exhaust a stored material might operate up to the 800 seconds range. The theoretical Isp of fission fragment kinetic energy propulsion is 1,220,000 seconds, a quantum leap from current technologies, up to the level essential for missions to the outer reaches of our solar system and beyond.

### FEDERALLY SPONSORED RESEARCH

Not Applicable

### SEQUENCE LISTING OR PROGRAM

Not Applicable

### FIELD OF THE INVENTION

This invention relates to a propulsion system for travel to the outer reaches of our solar system and beyond. More specifically, it relates to a unique method to perform space propulsion, utilizing the kinetic energy of atom fragments produced by nuclear fissions.

### BACKGROUND OF THE INVENTION

Newtons's third law teaches that rocket propulsion is based upon the reaction principle—for every action there is an equal and opposite reaction. The thrust of a rocket in the forward direction is the reaction on its structure due to the ejection of high-velocity matter in the aft direction.¹
¹Pedersen, page 15; Young and Freedman, page 8-7; Zaehringer, page 54.

Chemical propulsion, by far the most common of all concepts in use today for rockets and other space-related propulsion devices, reacts chemicals to produce high temperature combustion gases. Propulsion is accomplished by expanding these gases through a nozzle to increase their velocity, thereby exhausting the gases overboard to produce thrust.

A key parameter used in evaluating propulsion candidates for deep space is specific impulse (Isp). Temperatures that can be reached by chemical reaction are limited by the energy level of chemical bonds, thereby limiting the Isp of chemical propulsion devices to approximately 400 seconds. Advanced space concepts using nuclear energy to heat a stored material and exhaust it in a gaseous form, might operate up to the Isp 800 seconds range.

At the moment of nuclear fission of an atom of Uranium (U-235), ˜85% of the total energy release is in the form of fission fragment kinetic energy.² At fission, each atom releases ˜200 million electron volts (Mev) of energy, comprised of:

| | | |
|---|---|---|
| fission fragment kinetic energy | 170 | Mev |
| beta particles, gamma rays, neutrons, neutrinos | 30 | Mev |
| total fission energy per U-235 atom | ˜200 | Mev |
| fission fragment kinetic energy | ˜85% | |

²Etherington, page 12-3.

The velocities at fission of heavy and light fragments average 1.0E9 and 1.4E9 centimeters per second (cm/sec) respectively.³ Fission Fragment Kinetic Energy Propulsion (FFKEP) achieves an unprecedented Isp of well over a million seconds by ejecting a portion of the high-velocity fission fragments in the general aft direction from its propulsion engine:

$$Theoretical Isp = \frac{exhaust velocity}{gravitational constant} = \frac{1.2 E 9 cm \text{/} sec}{981 cm \text{/} sec 2} = 1 \text{,} 220 \text{,} 000 seconds .$$

³ Weinberg and Wigner, page 131.

### DESCRIPTION OF PRIOR ART

Advanced propulsion concepts that have been proposed for deep space, together with Applicant's calculations for comparable FFKEP values of Isp (above) and for thrust/weight ratio⁴ are listed below and plotted in FIG. 1. They include several nuclear devices, as well as electric ion and photon engines. None has gained acceptance by the space community as a baseline concept for future national or international development.
⁴ Utility Patent Application Transmittal, item 17, pages 6-9.

Two performance criteria prominent in evaluations of space propulsion candidates, are Isp and thrust/weight ratio. Values for these characteristics are reported in the literature for conventional and advanced concepts.⁵ Although direct conversion of fission fragment kinetic energy has been proposed to produce electromagnetic radiations,⁶ and to generate electric power for space,⁷ no corresponding proposal for space propulsion exists.
⁵ Pederson, page 38.

⁶ Fletcher, page 10, paragraph 5.

⁷ Heindl, page 80.

| Propulsion Method | Isp. seconds | Thrust/Weight Ratio |
|---|---|---|
| Chemical, state-of-the-art | 400 | 10 |
| Nuclear heat exchanger | 800 | 10 |
| Nuclear-gaseous core | 3,000 | 5 |
| Nuclear explosive propulsion | 3,000 | 1 |
| Magnetohydrodynamics | 10,000 | 0.0001 |
| Nuclear-electric ion engines | 30,000 | 0.0003 |
| Fission Fragment K.E. Propulsion | >1,000,000 | 0.0002 |
| Nuclear-photon engines | 30,000,000 | 0.00001 |
| Photon reflection (solar sail) | infinite | 0.00001 |

### SUMMARY OF THE INVENTION

Fission Fragment Kinetic Energy Propulsion is a simple application of the awesome fission process. Neutron bombardment of a fissionable material causes atoms of the material to fission into high velocity fragments, which can directly create high specific impulse rocket propulsion.

Conversely, in order for nuclear fission fragments to support other propulsion concepts by providing electricity, original nuclear energy must pass through a series of energy changes, each requiring components and complexities. This can be appreciated by identifying the individual operations necessary to electricity driven concepts such as the ion engine. High velocity fission fragments are created and absorbed within the nuclear reactor, converting fission kinetic energy into thermal energy, which is transported to and energizes the moving components of a mechanical cycle such as Rankine or Brayton to generate electrical energy,⁸ which is conditioned to a voltage and current usable by the ion engine, which produces high velocity particles, which finally create high specific impulse propulsion and heat.
⁸Langton, pages 155 and 156

At the moment of nuclear fission, 85% of the enormous energies are contained within fission fragments traveling at 4% the speed of light. FFKEP taps into this brief moment to produce spacecraft thrust, before kinetic energy converts to heat. By limiting the quantity of material fissioning at a given moment to well below critical mass, a catastrophic excursion is avoided. Fission energy is managed by the automatic removal of kinetic energy carried within fission fragments traveling generally aftward, and removal of waste thermal energy via spacecraft discharge fins.

Because nuclear energy is the most compact form of energy known, and because fission fragments are the highest velocity mass adaptable to space propulsion known, FFKEP is a quantum leap above other propulsion technologies competing for a lead role in exploration of the outer regions of our solar system and beyond.

### BRIEF DESCRIPTION OF DRAWINGS

FIG. 1 relates the characteristics of different space propulsion concepts to key performance criteria.

FIG. 2 shows a typical FFKEP location in relation to other major components of a hypothetical spacecraft.

FIG. 3 is an aft view partly in section and a section view of a nuclear rocket propulsion engine, the two views together embodying the present invention.

### DETAILED DESCRIPTION

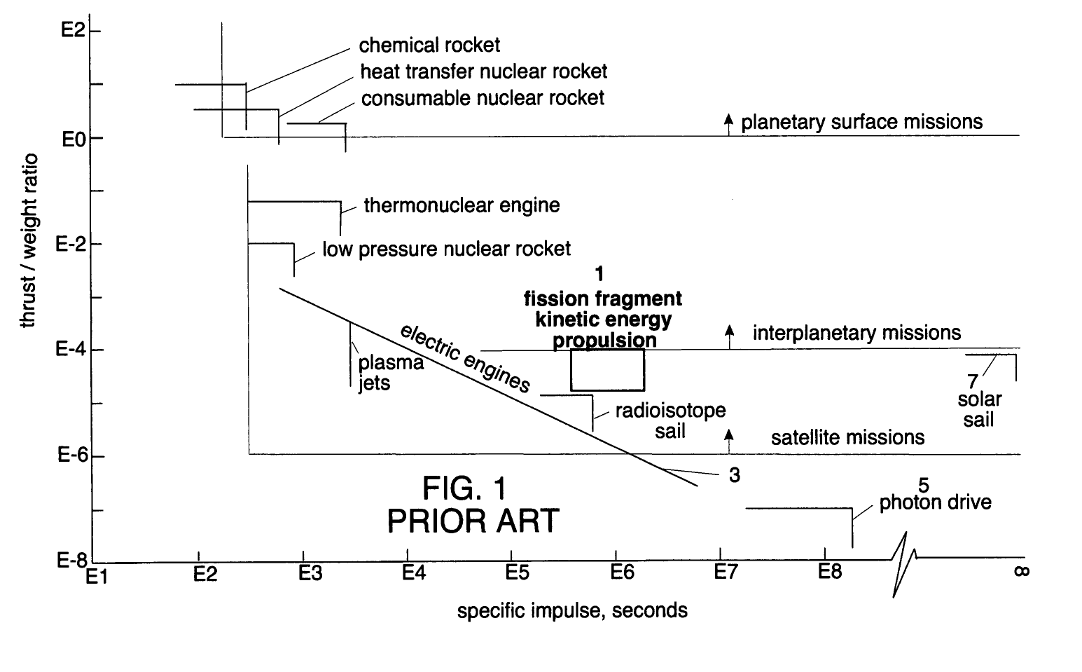

FIG. 1 relates performance characteristics of space propulsion concepts, previously listed in the “Description of Prior Art”. The Isp value of FFKEP 1 outdistances all other concepts except photon 5 and solar sail 7 devices, and a low thrust-to-weight version of the electric ion engine 3. Although photon concepts offer high Isp, their thrust-to-weight values are inherently low (i.e. a flashlight propelling itself through space). This low thrust characteristic is due to their propulsion being created by photons of energy, rather than by the high kinetic energies of fission fragment mass. An additional disadvantage of solar concepts is the weakening of our sun's energy rays (lower thrust) as distances from the sun increase.

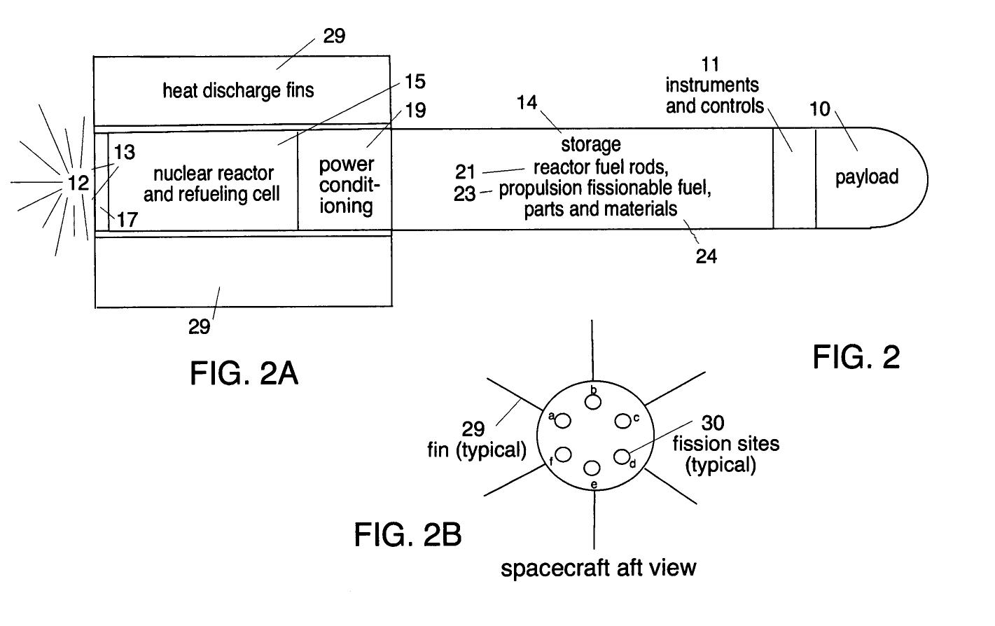

FIG. 2 is an overview showing typical major components of a spacecraft configured for FFKEP. Propulsion fission fragments 12 are created aft of the heat sink—heat exchanger 17 at the fission zone 13. Support functions are located within spacecraft compartments, as labeled. The nuclear reactor 15 generates and delivers neutrons to FFKEP, as well as providing electrical power. FIG. 2A also shows the payload compartment 10, instruments and controls compartment 11, and the heat discharge fin assembly 29.

After the supply of reactor fuel rods 21, propulsion fissionable fuel 23, and parts and materials 24 becomes depleted by usage, and spent components are ejected from the craft, the remaining supply will be stored along outer walls of the spacecraft. This strategy will allow spacecraft maneuverability by computerized load shifting, without adding thrust vector control complexities to propulsion components or procedures.

The quantity of fission sites 30a-f, six being shown in the FIG. 2B and chosen for presentation of this patent application, is flexible and mission dependent. For example, the configuration shown can fire all six units continuously, opposite pairs in three separate burns, triangular combinations such as a-c-e followed by b-d-f in two burns, or any adjacent pair to assist turning maneuvers. Other configurations offer their unique advantages to specific missions, the nine-unit combination among the more versatile.

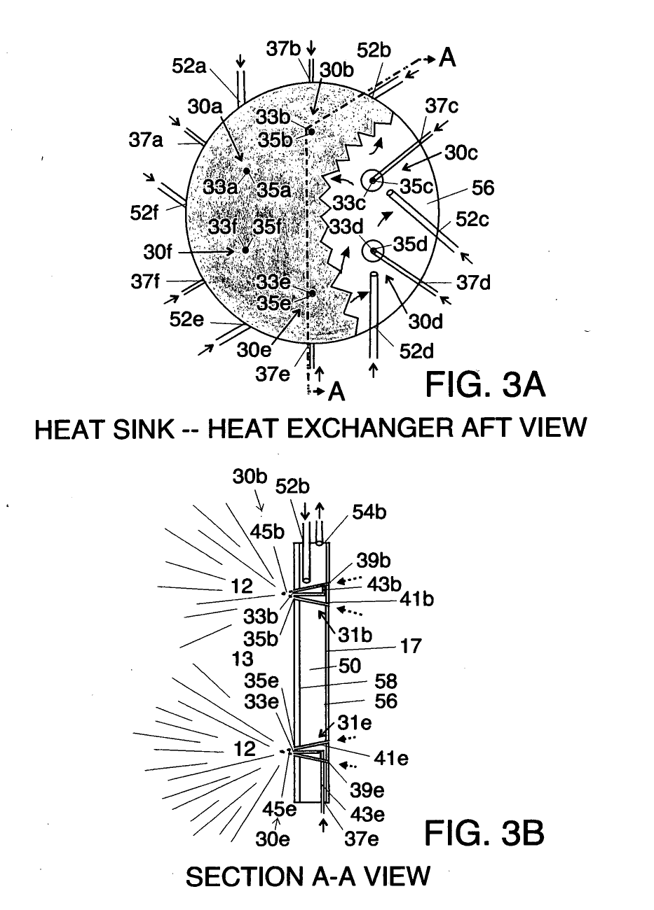

FIG. 3: The unique structure of the fission fragment kinetic energy propulsion engine (FFKEP) is comprised of a propulsion fission zone 13 containing multiple fission sites 30a-f; one or more heat sink—heat exchangers (HSHE) 17 common to the fission sites, interface structural provisions designed and fabricated to receive the flow of fissionable fuel 37a-f, thermal neutrons 39a-f and coolant 52a-f; and to control the flow of fissionable fuel 43a-f, neutrons 41a-f, 35a-f, and 45a-f, and coolant 50 and 54a-f. The direct usage of fission fragment kinetic energy to produce spacecraft propulsion, the foundation of this invention, dictates a major structural change from that which is common to nuclear heat-transfer prior art—solid core and gas core propulsion. FFKEP has no outer shell or nozzle. By freeing the propulsion fission zone 13 from a containment structure, fission fragments 12 launch directly into space at an average velocity of 1.2E9 centimeters per second, or 1.2E9/3.0E10=4% the speed of light.⁹ This enormous fission fragment velocity equates to an unprecedented theoretical propulsion specific impulse of 1.22 million seconds.
⁹ Weinberg and Wigner, page 131.

The HSHE is fabricated of a high temperature material, for example tungsten (melting point 3370° C., 6100° F.), and has a design operating temperature of 2500° C., 4532° F.). Higher melting point materials, but having less rocket industry experience, also are available¹⁰. FFKEP utilizes prior art technologies for injection of sub critical-mass quantities of fissionable gas¹¹ and thermal neutrons¹² into its propulsion fission sites 30a-f to cause nuclear fissions¹³. Other prior art is utilized to collect waste nuclear heat, and transport it to spacecraft heat management facilities 50, 54a-f.¹⁴
¹⁰ Rom, U.S. Pat. No. 3,202,582, column 1, lines 49-53.

¹¹ Rom, U.S. Pat. No. 3,202,582, column 4, lines 19+; Rom, 3, 574,057, column 3, lines 22+; Weinbaum, U.S. Pat. No. 3,714,782, column 1, lines 63+ and column 2, lines 15+.

¹² Rom, U.S. Pat. No. 3,202,582, column 4, lines 19+; Rom, 3, 574,057, column 3, lines 1+; Weinbaum, U.S. Pat. No. 3,714,782, column 1, lines 10+.

¹³ Etherington 4-91 and 5-83, 84; Rom, 3,202,582, FIG. 1; Rom, U.S. Pat. No. 3,574,057, FIG. 1; Weinbaum, U.S. Pat. No. 3,714,782, FIG. 1.

¹⁴ Rom, U.S. Pat. No. 3,574,057, column 2, lines 53+.

FFKEP requires that fissionable fuel 37a-f entering the HSHE be in the gaseous state. A common form of gaseous fissionable material is uranium hexafluoride (UF6), having been thoroughly characterized during early Gaseous Diffusion Separations programs¹⁵. As an alternate approach to UF6, fissionable materials can be stored as solids in neutron-safe facilities and transported to FFKEP as a heated vapor, or as powder entrained in a carrier gas before vaporizing in heated fuel feed piping¹⁶ prior to entering FFKEP. In either approach, fissionable vapor continuously enters the HSHE 17 at each feed inlet 37a-f, and is transported through tungsten tubing 43a-f to fission sites 30a-f. The tubes are clad with boron carbide (B4C)¹⁷ or other suitable neutron absorbing materials to prevent fissions within the tubing, and routed along the coolant zone forward surface 56 to each neutron cone 45a-f.
¹⁵ Etherington, pages 14-38 through 14-43.

¹⁶ Rom, U.S. Pat. No. 3,574,057, column 3, lines 26-33.

¹⁷ Rom, U.S. Pat. No. 3,202,582, column 3, lines 65-70; Perry, page 113.

FFKEP is inherently a low thrust—long duration propulsion invention. Fissionable material feed rates are far lower than for nuclear heat-transfer rocket concepts. Although optimum FFKEP feed rates vary for different missions, a representative value for gaining perspective is 0.01 gram per second of fully enriched Uranium isotope 235 (U-235), for the six-fission zone configuration shown in FIG. 3/3. Continuous propulsion at this feed rate equates to only ˜700 pounds per year of U-235 fuel consumption. Diameter of the HSHE 17 and Fission Zone 13 can be made significantly larger than the spacecraft diameter, in order to provide surface area for additional fission sites. This inherent flexibility can be utilized to lessen the heat load at individual fission sites, while maintaining constant spacecraft thrust; or to hold constant the heat load at individual fission sites, while increasing spacecraft thrust. However, the nuclear reactor diameter must be at least as large as that of the Fission Zone. The revolutionary low rocket fuel feed rate of the FFKEP invention—made possible by fission being the most compact energy form known, and fission fragments being the highest velocity mass adaptable to space propulsion known—allows extremely long-duration missions at continuous high-performance propulsion, due to the manageable mass of fissionable fuel required.

Mating the forward surface of the HSHE 17 with the aft surface of the spacecraft nuclear reactor (FIG. 2, #15), allows direct delivery of reactor neutrons to the HSHE neutron inlets 39a-f.¹⁸ The nuclear reactor also provides an on-off control of neutron flow from the reactor¹⁹ to HSHE. Channels in the neutron transfer assemblies 31a-f are designed and constructed to align with corresponding channels of the nuclear reactor, such that neutron beams pass through neutron assembly channels 41a-f exiting into fission sites 30a-f to form neutron cones 45a-f.
¹⁸ Etherington, pages 4-91 and 5-83, 84.

¹⁹ Etherington, pages 4-91 and 5-83, 84; Rom, 3,202,582, column 6, lines 3+.

Neuron transfer assemblies 31a-f shown in FIGS. 3A and 3B are concentric truncated cones, one fitted within the other, sized and with ribs or tubing to create narrow channels between the cones when joined together. The cones are fabricated of tungsten, preferably enriched with tungsten isotope 184 to neutralize the high thermal neutron capture crossection of tungsten.²⁰ Neutrons pass through the channels, exiting the HSHE at fission sites 35a-f to sustain continuous neutron cones 45a-f. Multiple tungsten cones can be fabricated into the assemblies, to produce multi-layered neutron cones, although those shown in FIG. 3/3 are single-layered cones. Within the neutron cones 45a-f, fissionable
²⁰ Rom, 3,202,582, column 3, lines 26-33. atoms are bombarded with thermal neutrons to create fission fragments 12, whose kinetic energy directly produces spacecraft thrust²¹.

²⁰ Rom, U.S. Pat. No. 3,202,582, column 3, lines 26-33.

²¹ Young and Freedman, page 8-7; Zaehringer, page 54.

The rate of U-235 fissions within the fission sites 30a-f and the portion of fission fragments remaining in the HSHE 17 aft wall, determine the thermal release into the wall. The portion of fission fragments 12 exiting the fission zones as propulsion elements (fission fragments) carry their total energy with them. The portion burrowing into the HSHE aft wall, release their kinetic energy as heat. HSHE coolant rapidly transports this heat from the coolant zone aft surface 58 through the coolant zone 50 to coolant discharge connections 54a-f, and on into the spacecraft heat management system. The heat either will be radiated into space by the spacecraft heat rejection fins, or utilized in some function such as thermionic generation of electricity.

The FFKEP baseline for performing the above transfer of heat utilizes molten metal coolant technologies developed during decades of breeder reactor programs in the United States and abroad.²² The latest operational nuclear reactor to utilize molten metal coolant technology, prior to its retirement in 1992, is the Fast Flux Test Facility.²³ FFKEP injects fresh coolant 52a-f directly onto the aft wall of coolant zone 50 adjacent to each fission site 30a-f. The angular orientation of tungsten injection piping 52a-f creates a swirling flow along the coolant zone aft (heated) surface 58, sweeping throughout coolant zone 50, and exits with its heat load along the less heated forward wall 56 through outlet connections 54a-f. Because breeding concepts operate at moderate temperatures, compared with rocket propulsion, sodium (melting point 97.8° C., 208° F.; boiling point 883° C., 1621° F.) was the preferred coolant. However, higher melting/boiling point metals were evaluated, up to tin (melting point 232° C., 449° F.: boiling point 2270° C., 4118° F.²⁴. Other materials representing obvious extensions of the art include beryllium (melting point 1284° C., 2343° F.; boiling point 2767° C., 5013° F.), and titanium (melting point 1800° C., 3272° F.; boiling point >3000° C., >5432° F.).²⁵
²² Etherington 13-80 through 13-104; U.S. Department of Energy, FFTF@rl.gov.

²³ U.S. Department of Energy, FFTF@rl.gov.

²⁴ Etherington, page 13-81, 82.

²⁵ Perry, page 113, 127.

1-9. (canceled)

10. A spacecraft propulsion engine that directly uses the kinetic energy of nuclear fission fragments to produce spacecraft thrust, comprising:
a. a heat sink with one or more of its surfaces not located within a containment structure or any other form of outer shell.
b. a heat exchanger for removal of nuclear fission waste heat.
c. a sub critical-mass fission zone external to the spacecraft, not located within a containment structure or any other form of outer shell.

11. A spacecraft propulsion engine as in claim 1, further comprising:
means to launch a portion of said fission fragments generally in the aft direction, and a separate portion generally in the forward direction.

12. A spacecraft propulsion engine as in claim 1, further comprising:
means to produce said spacecraft thrust without any form of structure to utilize a light propellant, for example hydrogen.

13. A spacecraft propulsion engine as in claim 1, further comprising:
a. said heat sink and/or said heat exchanger made of tungsten or other high melting point material.
b. a structural flexibility whereby said heat sink, heat exchanger and fission zone diameter is larger, smaller or the same as said spacecraft diameter.
c. a structural flexibility whereby said fission zone contains multiple fission sites.
d. fissionable fuel tubes made of or clad with boron carbide or other suitable neutron absorbing materials.
e. neutron transfer assemblies made of tungsten or tungsten enriched with tungsten isotope 184.
f. said neutron transfer assemblies fabricated to form either single-layered or multi-layered neutron cones.
g. said fissionable fuel tubes and neutron transfer assemblies configured to cause neutron bombardment of fissionable fuel by direct impingement.
h. said heat exchanger designed and fabricated for operation using a molten metal coolant.
i. said molten metal coolant consisting of sodium, a sodium and potassium mixture, or a higher melting and boiling point coolant, for example tin, beryllium or titanium.
